(19) United States
(12) Patent Application Publication
(10) Pub. No.: US 2017/0153717 A1
(43) Pub. Date: Jun. 1, 2017

(54) Graphical User Interface for Designing Terrain Modification Plans

(71) Applicant: Caterpillar of Australia Pty Ltd., Victoria (AU)

(72) Inventors: Christina Moore, Queensland (AU); Brett Eisenmenger, Queensland (AU); Raymond Choong, Queensland (AU); Joseph Glynn, Greenslopes (AU)

(73) Assignee: Caterpillar of Australia Pty Ltd., Victoria (AU)

(21) Appl. No.: 15/360,136

(22) Filed: Nov. 23, 2016

(30) Foreign Application Priority Data
Nov. 25, 2015 (AU) 2015261600

(51) Int. Cl. G06F 3/0354; G06F 3/0484; G06F 3/06; G06F 3/0346

(52) U.S. Cl. CPC G06F 3/0354; G06F 3/0346; G06F 3/04847; G06F 3/065; G06F 3/0685; G06F 3/0619

(57) ABSTRACT

Described herein is a computer processing system configured to: display a profile depiction of a work site terrain feature being designed, the profile depiction comprising a design plane line depicting a desired surface profile of the terrain feature; receive input from a pointing device, the input adjusting the elevation of a point on the design plane line; based on receiving input adjusting the elevation of the point on the design plane line, recalculate coordinates of the design plane line in accordance with the input received from the pointing device; and redisplay the design plane line in accordance with the recalculated coordinates.

### TECHNICAL FIELD

This disclosure relates generally to a graphical user interface for designing terrain modification plans and, in particular, slot dozing plans.

### BACKGROUND

Operations to modify topography are common in many work sites. For example, in mining work sites machines such as dozers are frequently operated to excavate and move material from one work site location to another, thereby changing the work site topography.

A work site machine may operate in an autonomous or semi-autonomous manner in accordance with terrain modification plans. Terrain modification plans are often generated at a command centre, with human operator input, and are then communicated to the relevant machine so the plan can be carried out by that machine.

Machine operations are typically overseen and/or controlled by human operators working in a command centre/environment that is remote to the actual machines. Machine control may be manual control (e.g. remote real-time control of a machine by a human operator) and/or indirect control (e.g. the generation and communication of assignments to a machine which are carried out by the machine autonomously or semi-autonomously). Even where assignments are carried out by a machine autonomously or semi-autonomously, operations of the machine are often overseen by a human controller.

An operator controls and oversees work site operations using one or more computer systems (generally referred to as a command system). A command system receives data from various work site machines and work site sensors which is processed and used to provide the operator with real-time information on current machine operations and the environment in which the machines are operating. A command system is also used to control the operation of work site machines, for example by generating assignments for machines and communicating those assignments to the machines and/or by directly controlling machine operations.

Various data is received from the work site machines and sensors to provide information on the current state of the work site. This includes, for example, data in respect of the work site terrain, the positions of machines on the work site, the current operational parameters of machines operating on the work site, current machine assignments, future machine assignments etc. A given operator may oversee and control (either directly or by communication of assignments to machines) the operation of multiple machines at the same time. In order to do this the operator needs to monitor large volumes of data relevant to the operation of the machines the operator is controlling/monitoring and the work site environment.

Much of the data received from work site machines and sensors is presented to an operator in visual form, often on multiple display screens that an operator must concurrently monitor. Whilst keeping atop of the large amount of information being presented, the operator must also interact with the command system in order to input control information.

Within such a complex environment, the manner in which an operator interacts with a command system is critical. Any mechanism which can simplify or speed up the operator's job of absorbing information in respect of the work site and machines and/or entering control information can provide a significant advantage.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

Described herein is a computer processing system comprising: a computer processing unit; computer readable memory in communication with the computer processing unit, the computer readable memory storing instructions executable by the computer processing unit to cause the computer processing system to: display, on a display, a profile view of a work site terrain feature being designed, the profile view comprising a design plane line depicting a desired surface profile of the terrain feature; receive input from a pointing device, the input adjusting the elevation of a point on the design plane line; based on receiving input adjusting the elevation of the point on the design plane line, recalculate coordinates of the design plane line in accordance with the input received from the pointing device; and redisplay the design plane line in accordance with the recalculated coordinates.

Also described herein is a non-transitory computer-readable medium comprising instructions which, when implemented by a computer processing system, cause the computer processing system to: display, on a display, a profile view of a work site terrain feature being designed, the profile view comprising a design plane line depicting a desired surface profile of the terrain feature; receive input from a pointing device, the input adjusting the elevation of a point on the design plane line; based on receiving input adjusting the elevation of the point on the design plane line, recalculate coordinates of the design plane line in accordance with the input received from the pointing device; and redisplay the design plane line in accordance with the recalculated coordinates.

### BRIEF DESCRIPTION OF THE DRAWINGS

Various aspects and features will be described with reference to the following figures which are provided for the purposes of illustration and by way of non-limiting example only.

FIG. 1 is a schematic view of a work site at which a machine incorporating the principles disclosed herein may be used;

FIG. 2 is a diagrammatic illustration of a dozing machine;

FIG. 3 is a block diagram of a computer processing system which can be used to implement various features of this disclosure;

FIG. 4 is a cross-sectional depiction of a slot in a work site;

FIG. 5 is a depiction of a graphical user interface for designing a terrain modification plan (in particular a slot dozing plan); and

FIG. 6 is a flowchart illustrating processing involved in designing a terrain modification plan using the graphical user interface of FIG. 5.

### DETAILED DESCRIPTION

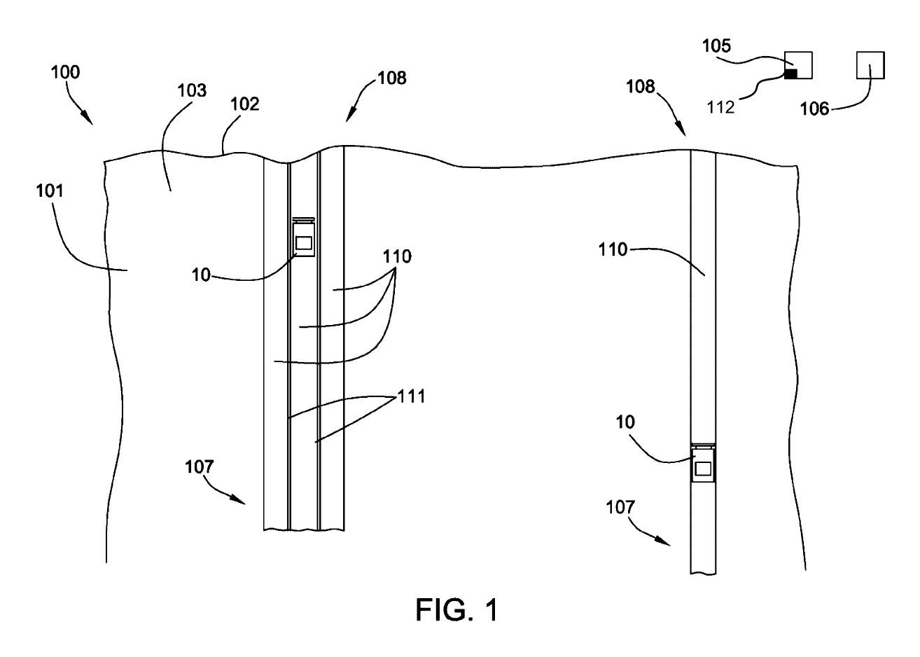

FIG. 1 is a diagrammatic illustration of a portion of a work site 100 at which one or more machines 10 may operate. Work site 100 may be a mining site, a landfill, a quarry, a construction site, or any other area in which the movement of material is desired.

Operations which involve altering the terrain of the work site 100 are common. Such operations involve moving material from one location to another, for example by the operation of dozing machines. As depicted, work site 100 includes a work area 101 having a crest 102 defining an edge of a ridge, embankment, high wall or other change in elevation. Work surface 103 may take any form and refers to the actual profile or position of the terrain of the work area.

### Work Site Machines

Operations on the work site 100 are carried out by various machines 10. Machines 10 may be manually operated or may operate autonomously or semi-autonomously.

As used herein, a machine 10 operating in an autonomous manner operates automatically based upon control information (e.g. assigned tasks or plans) and information received from various sensors without the need for human operator input. As an example, a haul truck that automatically follows a path from one location to another and dumps a load at an end point may be operating autonomously. A machine 10 operating semi-autonomously includes an operator, either within the machine 10 or remotely, who performs some tasks or provides some input and other tasks are performed automatically and may be based upon information received from various sensors. As an example, a truck that automatically follows a path from one location to another but relies upon an operator command to dump a load may be operating semi-autonomously. In another example of a semi-autonomous operation, an operator may dump a bucket of an excavator in a load truck and a controller may automatically return the bucket to a position to perform another digging operation. A machine being operated manually is one in which an operator is controlling all or essentially all of the functions of the machine. A machine 10 may be operated remotely by an operator (i.e., remote control) in either a manual or semi-autonomous manner.

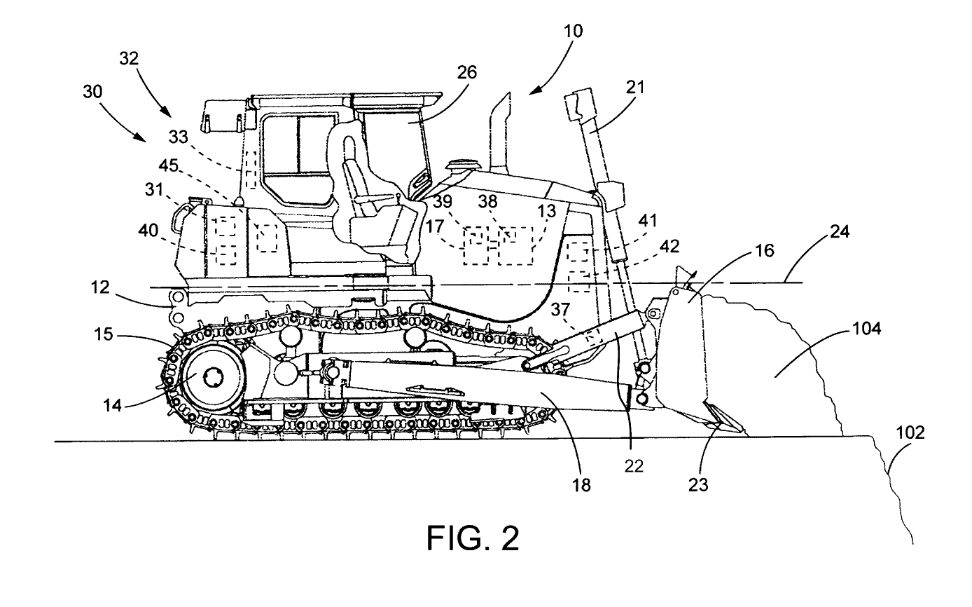

FIG. 2 shows a diagrammatic illustration of a machine 10 such as a dozer adjacent crest 102 with a work implement 16 (in this case a blade) pushing material 104 over the crest. The machine 10 includes a frame 12 and a prime mover such as an engine 13. A ground-engaging drive mechanism such as a track 15 is driven by a drive wheel 14 on each side of machine 10 to propel the machine 10. Although machine 10 is shown in a “track-type” configuration, other configurations, such as a wheeled configuration, may be used. Operation of the engine 13 and a transmission (not shown) which are operatively connected to the drive wheels 14 and tracks 15 may be controlled by a machine control system 30 including a machine controller 31. Other types of prime movers and drive systems are contemplated.

Machine 10 includes a ground engaging work implement such as blade 16 pivotally connected to frame 12 by arms 18 on each side of machine 10. First hydraulic cylinder 21 coupled to frame 12 supports blade 16 in the vertical direction, and allows blade 16 to move up or down vertically from the point of view of FIG. 2. Second hydraulic cylinders 22 on each side of machine 10 allow the pitch angle of blade tip 23 to change relative to a centreline 24 of the machine.

Machine 10 is equipped with a plurality of sensors that provide data indicative (directly or indirectly) of various operating parameters of the machine. For example, a hydraulic system may include sensors for monitoring pressure within the system as well as the pressure of specific cylinders. For example, one or both of the second hydraulic cylinders 22 may include an associated pressure sensor 37. Sensors may be provided to monitor the operating conditions of the engine 13 and the associated drivetrain such as an engine speed sensor 38 and a torque converter speed sensor 39. The machine may also include an accelerometer 40 for determining the acceleration of the machine along various axes. Still further, a pitch angle sensor 41 and a pitch rate sensor 42 may be included for determining roll, pitch and yaw of machine 10. Other sensors necessary or desirable for operating the machine 10 may be provided.

Machine 10 may be controlled by a machine control system 30 that interacts with a positioning system such as a global positioning system (“GPS”) to monitor and/or control the movement of the machine about the work site 100. The control system 30 may be located on the machine 10 and/or may be located at a command centre 105 (FIG. 1) located remotely from the machine. In certain embodiments, the functionality of machine control system 30 may be distributed so that certain functions are performed at machine 10 and other functions are performed at command centre 105. For example, a network system such as wireless network system 106 (FIG. 1) may provide generalized commands (for example machine assignments) and/or other information to the machine 10 that the portions of machine control system 30 on the machine utilize to generate specific commands to operate the various systems of machine 10. In the alternative, aspects of the machine control system 30 remote from the machine 10 may provide some or all of the specific commands that are then transmitted by the wireless network system 106 to systems of the machine. Machine 10 may be one of a plurality of machines operating at work site 100, each of which may communicate with a remote command centre such as 105 via a wireless network system 106.

Rather than operating the machine 10 in an autonomous manner, an operator may have the ability to operate the machine 10 remotely such as with a wireless control unit 45. Still further, machine 10 may also include a cab 26 that an operator may physically occupy and provide input to control the machine. Cab 26 may include one or more input devices through which the operator issues commands to control the propulsion and steering of the machine as well as operate various implements associated with the machine. In one embodiment, machine 10 may be configured to be operated autonomously, semi-autonomously, or manually. In case of semi-autonomous or manual operation, the machine may be operated by remote control and/or by an operator physically located within the cab 26.

The machine control system 30, as shown generally by an arrow in FIG. 2 indicating association with the machine 10, may include an electronic control module or machine controller 31. The machine controller 31 may receive input command signals from the wireless network system 106, remote control input command signals from an operator operating machine 10 remotely, or operator input command signals from an operator operating the machine 10 from within cab 26. The machine controller 31 may control the operation of the drivetrain as well as the hydraulic systems that operate the ground engaging work implement such as blade 16. The machine control system 30 may include one or more sensors to provide data and other input signals representative of various operating parameters of the machine 10. The term “sensor” is meant to be used in its broadest sense to include one or more sensors and related components that may be associated with the machine 10 and that may cooperate to sense various functions, operations, and operating characteristics of the machine.

The machine controller 31 may be an electronic controller that operates in a logical fashion to perform operations, execute control algorithms, store and retrieve data and other desired operations. The machine controller 31 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry. In certain embodiments, machine assignments (such as terrain modification plans or slot dozing plans as described further below) are communicated to a machine 10, stored in memory of the machine, and processed by the machine controller 31 to cause the machine to carry out the assignment.

The machine controller 31 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the machine controller 31 may be implemented in hardware and/or software without regard to the functionality. The machine controller 31 may rely on data relating to the operating conditions of the machine 10 that may be stored in memory.

A position sensing system 32, as shown generally by an arrow in FIG. 2 indicating association with the machine 10, may include a position sensor 33 to sense a position of the machine relative to the work area 101. The position sensor 33 may include a plurality of individual sensors that cooperate to provide signals to machine controller 31 to indicate the position of the machine 10. The machine controller 31 may determine the position of the machine 10 within work area 101 as well as the orientation of the machine 10 such as its heading, pitch and roll. In doing so, the dimensions of the machine 10 may be stored within the machine controller 31 with the position sensing system defining a datum or reference point on the machine 10 and the controller using the dimensions to determine the position of the terrain or work surface 103 upon which the machine is 10 moving. Position sensor 33 may be a series of GPS sensors, an odometer or other wheel rotation sensing sensor, a perception based system or may use other systems such as lasers to determine the position of machine 10.

### Terrain Modification and Slot Dozing

Machine 10 may perform various terrain modification operations at work site 100.

One type of operation performed by machine 10 is slot dozing where machine 10 operates in accordance with a terrain modification plan assigned to the machine 10 to move material from an initial location 107 to a spread or dump location 108. The dump location 108 may be at crest 102 or at any other location.

One particular type of terrain modification operation involves assigning plans to machine(s) 10 which cause the machine(s) 10 to form a plurality of spaced apart channels or slots 110 that are cut into the work surface at work site 100 along a path from the initial location 107 to the dump location 108. In doing so, a machine 10 moves back and forth along a linear path between the initial location 107 and the dump location 108. If desired, a relatively small amount of material may be left or built up as walls 111 between adjacent slots 110 to prevent or reduce spillage and increase the efficiency of the material moving process. The walls 111 between the slots 110 may be moved after the slots are formed or periodically as desired.

This process of moving material through slots 110 while utilizing walls 111 of material to increase the efficiency of the process is sometimes referred to as “slot dozing.

### Command System

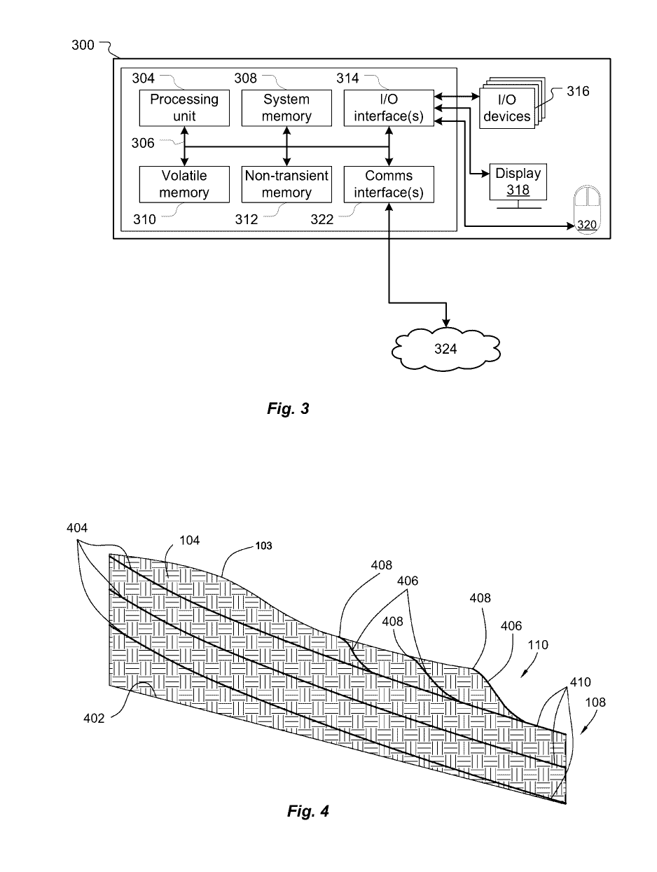

In order to oversee and control machine 10 operations, a human operator interacts with a command system 112 in a remote command centre 105. Command system 112 is made up of one or more computer processing systems. FIG. 3 provides a block diagram of a computer processing system 300 which, in certain embodiments, is or forms part of a command system 112.

In the present example, the computer processing system 300 comprises at least one processing unit 304. Processing unit 304 may be a single computational processing device (e.g. a microprocessor, a general processing unit, a graphical processing unit, or other computational device) or a plurality of computational processing devices. Through a communications bus 306 the processing unit 304 is in data communication with computer readable system memory 308 (e.g. a read only memory storing a BIOS for basic system operations), computer readable volatile memory 310 (e.g. random access memory such as one or more DRAM modules), and computer readable non-transient memory 312 (e.g. one or more hard disk drives, solid state drives, flash memory devices and suchlike). Instructions and data for controlling operation of the processing unit 304 are stored on the system, volatile, and/or non-transitory memory 308, 310, and 312.

Computer processing system 300 also comprises at least one input/output interface 314 which allow the computer processing system 300 to interface with various input/output devices 316. A wide variety of input/output devices may be used. For example, computer processing system 300 outputs data to one or more displays 318 (e.g. CRT, LED, LCD, plasma, touch screen and/or other displays).

In certain embodiments computer processing system 300 and receives input from a pointing device 320. As used herein a pointing device 320 is a device which provides input in the form of spatial data. As used herein, pointing devices 320 include cursor control devices such as mice, touch-pads, track-balls, pointing sticks, and joysticks which are used to control the position of a cursor or pointer displayed on a display and interact with displayed objects (e.g. by clicking on a graphical user interface element displayed at the position of the pointer/cursor). As used herein, pointing devices 320 also include devices such as touchscreens in which a user contacts (either with a finger or stylus) a touch sensitive screen positioned over a display to interact directly with graphical user interface elements (e.g. by tapping the touch screen at the position at which a graphical user interface element is displayed). Pointing devices 320 can be contrasted with keyboards and keypads which allow for input by pressing physical keys.

I/O interface(s) 314 can also be used to interface with other input and/or output devices, such as microphones (input), speakers (output), hard drives (input/output), solid state drives (input/output), flash memory devices (input/output) and the like.

Computer processing system 300 also comprises one or more communications interfaces 322, such as a Network Interface Card. Communications interfaces 322 are operated to provide wired or wireless connection to one or more communications networks 324. One such network 324 is wireless network system 106 shown in FIG. 1. Other networks 324 that computer processing system 300 connect to may include, for example, the Internet, local area networks, wide area networks, and/or other networks. Via the communications interface(s) 322 and network(s) 324, computer processing system 300 can communicate with other computer systems connected to the network 324. Such systems include, for example, machines 10 (or the computer processing systems carried thereby) operating at work site 100.

Communication with the communications network 324 (and other systems/devices connected thereto) is typically by the protocols set out in the layers of the OSI model of computer networking. For example, applications/software programs being executed by computer processing system 300 system may communicate using one or more transport protocols such as the Transmission Control Protocol (TCP, defined in RFC 793) or the User Datagram Protocol (UDP, defined in RFC 768). Alternative communications protocols may, of course, be used.

By operating the communications interface(s) 322, the computer processing system 300 can communicate with machines 10 operating on the work site 100 over a network such as 106. This communication enables the computer processing system 300 to send control messages and data to a machine 10, for example to update current assignments and/or work site information and/or or to take direct remote control of a machine 10. This communication also enables the computer processing system 300 to receive messages/data from machines 10 and other work site systems, for example to allow the computer processing system 300 to determine the current operational status/position etc. of machines 10 and display relevant work site information to an operator on a display 318.

Computer processing system 300 stores in memory (for example non-transient memory 312) and executes (by processing unit 304) one or more applications allowing operators to operate the computer processing system 300. Such applications will typically comprise at least an operating system such as Microsoft Windows®, Apple OSX, Unix, or Linux.

As described in detail below, the computer processing system 300 is configured to provide a graphical user interface (on a display such as 318) for designing a terrain modification plan. In one embodiment the computer processing system 300 is configured by the execution of software. Software is stored on memory (e.g. non-transient memory 312 or other computer readable memory accessible by the computer processing system 300) and comprises instructions (and data). The instructions are read into system memory (e.g. 308) and executed by the processing unit 304 to cause the computer processing system 300 to provide the various functions described.

In alternative embodiments, configuration of the computer processing system 300 may be by hardware circuitry or a combination of hardware circuitry and software.

Command system 112 may be made up of multiple computer processing systems such as system 300. Where multiple computer processing systems are used they may be located in the same or different places, and may be directly interconnected or interconnected via a network such as network 324.

### INDUSTRIAL APPLICABILITY

In order to facilitate the design of terrain modification plans, the present disclosure provides a graphical user interface. As described above, one type of terrain modification operation performed on work site 100 by machines 10 is slot dozing. The features of the graphical user interface will be described with reference to the design/planning of slot dozing operations. The graphical user interface may, however, be used (or be adapted to be used) for other terrain modification planning.

Slot dozing operations are initially planned by human operators and terrain modification plans (specifically slot dozing plans) are generated. Once generated, terrain modification plans are assigned to machines 10 (e.g. by communication over network 106). Terrain modification plans comprise instructions and data which are processed by the machine 10 (e.g. by the machine control system 30) to cause the machine 10 to modify the terrain in accordance with the plan.

FIG. 4 is cross-sectional depiction of a planned slot 110. Planned slot 110 has a final design plane 402—i.e. the desired profile of the work site that operations are to be performed to achieve. In the illustrated example, the depth of the final design plane relative to the starting surface 103 is too great for the final design plane 402 to be reached immediately. Accordingly, the depiction illustrates a number of intermediate design planes 404. A machine 10 (e.g. a dozer) is operated to remove material from the work surface 103 in accordance with intermediate design planes 404 until the final design plane 402 is reached. The blade 16 of machine 10 may engage the work surface 103 with a series of cuts 406 that are spaced apart lengthwise along the planned slot 110. Each cut 406 begins at a cut location 408 along the work surface 103 at which the blade 16 initially engages the work surface and extends into the material 104 towards the pass target or carry surface 410 for a particular pass. Machine controller 31 may be configured to guide the blade 16 along each cut 406 until reaching the carry surface 410 and then follow the carry surface towards the dump location 108.

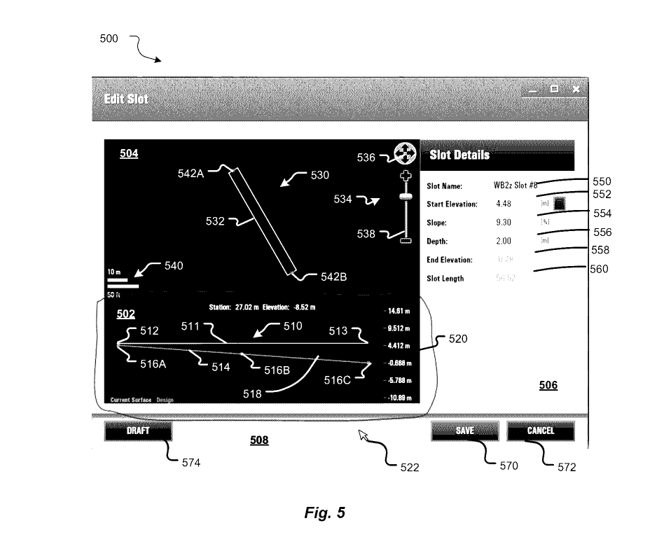

Creating slot designs to be used in slot dozing scenarios is challenging. This is particularly the case if the current surface topology and depth guide are not known (or not known accurately). In order to facilitate the slot design process, and referring to FIG. 5, computer processing system 300 is configured to provide a terrain design graphical user interface 500. The computer processing system 300 displays the user interface 500 on a display 318 (or across multiple displays 318).

The terrain design graphical user interface 500 may be launched by an operator by activation of an appropriate control. For example, computer processing system 300 may provide a control for an operator to design a new slot, e.g. by displaying a “new slot design” control on a display 318. When a user selects to design a new slot, computer processing system 300 generates a slot plan within a previously defined work-block. A work-block is an area of the terrain that has been designated for slot dozing and in which one or more slots will be planned. When a work-block is created it is associated with certain parameters, for example: the boundaries of the work-block; the width of each slot that will be planned within the work-block; the gap between adjacent slots within the work-block; a default slope for slots that are planned within the work-block (based, for example, on the height of the blade/other parameters of the machine that will be working in the work-block), etc. When a new slot is design the computer processing system 300 automatically positions the new slot in the work-block based on the boundaries of the work-block and the locations of any slots that have already been planned/formed within the work-block. Computer processing system 300 may also provide a control for an operator to modify an existing slot, e.g. by displaying a “modify slot design” control or similar. If a user elects to modify an existing slot design the computer processing system 300 either displays a list of current slot designs that the user has permission to modify or asks the user to enter an identifier for the slot to be modified.

Once a user has elected to design a new slot, or has selected an existing slot to modify, the computer processing system 300 launches graphical user interface 500. In the illustrated embodiment, user interface 500 comprises four main areas or panes: a profile view area 502, a top view area 504, a slot details area 506, and a controls area 508. Each area/pane will be described in turn.

### Profile View Area 502

In the profile view area 502 the computer processing system 300 displays a profile depiction 510 of the slot (or other terrain) being planned.

The profile depiction 510 comprises a current surface line 511 which depicts the current surface of the work site location at which the slot is planned. The current surface line has a slot start point 512 and a slot end point 513 (the distance between the slot start point 512 and slot end point 513 being the slot length which, at least initially, is determined by the length of the work-block in which the slot is being planned).

The profile depiction 510 also comprises a design plane line 514 which indicates a design plane of the slot being planned—i.e. the desired or intended surface of the terrain. When a new slot is created the design plane is initialised to a default slope—e.g. a default slope of 20% may be applied. In some embodiments the default slope of the design plane line 514 is dependent on the work-block in which the slot is being planned. In this case, the default design plane slope for a given work-block is entered as a parameter when the work-block is originally designed and entered into the system. Different work-blocks may have different default slopes for newly generated slot designs. In some cases the default slope of the design plane line 514 will be acceptable. In other cases the default slope may not be appropriate—e.g. due to the default slope (if followed) resulting in too much or too little material being moved. In this case the design plane line 514 can be adjusted by a user to a more optimal slope.

In the illustrated embodiment the design plane line 514 is associated with a plurality of design plane control points 516. In the illustrated example three design plane control points are provided: a design plane start control point 516A indicating a starting elevation of the slot being designed; a design plane mid control point 516B indicating the elevation of a mid-point of the slot being designed; and a design plane end control point 516C indicating an end elevation of the slot being designed. As can be seen, the design plane start control point 516A is vertically aligned with the slot start point 512, and the design plane end control point 516C is vertically aligned with the slot end point 513.

In the present embodiment a carry indication 518 is also displayed. The carry indication 518 is (in this case) displayed as a shaded area running the length of the design plane line 514 and provides an indication of the volume of material able to be carried by a machine 10 in a single pass. The carry indication 518 may be calculated based on the specific machine 10 (and/or operational parameters of the machine 10) which will be operated to perform the slot dozing operations. By way of example, it may be known (i.e. the computer processing system 300 may have access to memory storing relevant data) that the slot dozing assignment will be assigned to a Caterpillar D10 dozer carrying a 7 foot high work implement (i.e. blade 16) and capable of pushing 35 cubic yards of material. This, combined with the length and profile of the slot being designed, allows the computer processing system 300 to calculate and display the carry indication 518. In FIG. 5, the carry indication 518 indicates that the current design cannot be achieved with a single machine pass. This can be seen as at the design plane end control point 516C the top of the carry indication 518 falls below the current surface line 511.

The profile view area 502 also provides a reference axis 520 against which the profile depiction 510 of the slot is plotted/displayed. In this example the reference axis is a vertical axis. The reference axis 520 comprises a number of elevation indicators which indicate an elevation of various points on the profile depiction 510.

A user can use a pointing device 320 to interact with and change the design plane line 514. For example, a user may interact with a design plane control point 516 to change its elevation and, accordingly, the slope of the design plane line 514.

When the elevation of a design plane control point 516 is adjusted by the user the computer processing system 300 recalculates the coordinates of the design plane line 514 and (accordingly) the positions of any affected control points 516. The computer processing system 300 then redisplays the profile depiction 510 to show the changes that have been made. As described further below, adjusting the elevation of a control point 516 causes corresponding adjustments to be made to the slope of the design plane line 514 (and the carry indication 518) as well as the elevations of one or more other control points 516. As also described further below, when adjustments to the slot design are made these adjustments are reflected numerically in the slot details area 506.

Interaction with the design plane line 514 (or a control point 516) is via a pointing device 320. If the pointing device 320 is a mouse/trackball/track-pad/joystick or the like, a user operates the pointing device 320 to move a cursor 522 around the interface 500. Using the pointing device 320 an operator can position the cursor 522 over the desired design plane control point 516, operate a control of the pointer device 320 (e.g. click/press a button on the pointing device 320), and move the pointing device 320 to drag the control point 516 to the desired location. As an alternative example, if the pointer device 320 is a touch screen display, a user may contact the display directly on a control point 516 using a finger (or stylus) and move their finger/stylus to drag the control point 516 to the desired location.

Dragging a control point 516 up increases the elevation of the control point 516 while dragging a control point 516 down decreases the elevation of the control point 516.

Changing the elevation of a control point 516 also changes the angle or slope of the design plane line 514. The computer processing system 300 processes movement of a design plane control point 516 in such a way that the design plane line 514 remains straight.

For example, if a user interacts with the design plane end control point 516C, the computer processing system 300 recalculates the coordinates of the design plane line 514 to be a straight line joining the design plane start control point 516A (maintained in its original position) and the design plane end control point 516C (in its adjusted position).

By way of further example, if a user interacts with the design plane start control point 516A, the computer processing system 300 recalculates the coordinates of the design plane line 514 to be a straight line joining the design plane start control point 516A (in its adjusted position) and the design plane end control point 516C (in its original position).

In certain embodiments, the computer processing system 300 only enables direct manipulation of the design plane start control point 516A and design plane end control point 516C (i.e. direct adjustment of the design plane mid control point 516B is disabled and is provided as a visual reference point only). In other embodiments, direct manipulation of the design plane mid control point 516B is enabled. For example, and where enabled, if a user manipulates with the design plane mid control point 516B, the computer processing system 300 recalculates the coordinates of the design plane line 514 to be a straight line from the design plane start control point 516A (in its original position), passing through the design plane mid control point 516B (in its adjusted position), and terminating at the design plane end control point 516C in a newly calculated position (the new position of the design plane end control point 516C calculated to account for the adjustment to the design plane mid control point 516B and to be vertically aligned in line with the slot end point 513).

To assist in usability, the computer processing system 300 may be configured to permit or restrict interaction with the profile depiction 510 (and in particular the final design plane line 514) in various ways. Several examples are provided below.

In certain embodiments the computer processing system 300 is configured to restrict movement of a design plane control point 516 to upward/downward movement—i.e. so only the elevation of a control point 516 can be changed. In these embodiments the computer processing system 300 is configured to ignore/discard any lateral (left/right) component of the pointing device 320 movement while a design plane control point 516 is being dragged and moves the control point 516 in question based only on the vertical (up/down) component of the pointing device 320 movement.

In certain embodiments the computer processing system 300 is configured to permit a user to interact with any point on the design plane line 514—e.g. by clicking/contacting any point on the line 514 and dragging it. In this case, in order to calculate the coordinates of the new design plane line 514 (and design plane control point 516 positions) the computer processing system 300 is configured to determine whether to maintain the start elevation (e.g. 516A) or end elevation (e.g. 516C) of the design plane line 514 in its original position. This determination may be made based on the distance along the design plane line 514 from the start and/or end point at which the user interacts.

For example, in certain embodiments if a user interacts with the line 514 at a point closer to the design plane end control point 516C than the design plane start control point 516A, the computer processing system 300 is configured to maintain the position of the design plane start control point 516A and calculate the coordinates of a design plane line 514 that joins design plane start control point 516A (in its original position), passing through the point on the design plane line 514 adjusted by the user, and terminating at the design plane end control point 516C in a newly calculated position (the new position of the design plane end control point 516C calculated to account for the adjusted design plane point and to be to be positioned in line with the end point 513 of the current surface line 511).

Conversely, if a user interacts with the line 514 at the middle or a point closer to the design plane start control point 516A than the design plane end control point 516C, the computer processing system 300 is configured to maintain the position of the design plane end control point 516C and calculate the coordinates of a design plane line 514 that joins design plane end control point 516C (in its original position), passing through the point on the design plane line 514 adjusted by the user, and terminating at the design plane start control point 516A in a newly calculated position (the new position of the design plane start control point 516A calculated to account for the adjusted design plane point and to be to be positioned in line with the start point 512 of the current surface line 511).

In alternative embodiments, the computer processing system is configured to always maintain the design plane start control point 516A in its original position unless the interaction with the line 514 occurs within a predefined distance of the design plane control point 516A. The predefined distance may be set as desired—for example within one to two centimetres of the design plane start control point (as measured on the actual display).

In certain embodiments the computer processing system 300 is configured to display in the profile view area 502 current elevation details with respect to the design plane line 514 as it is being adjusted. Current elevation details may be displayed, for example, in a pop-up box that is presented at or near the location the user is interacting with the design plane line 514 in order to allow the user to see current elevation details without diverting attention to either the axis 520 or slot details area 504. Current elevation details may comprise: the elevation of the design plane end control point 516C; the depth of the design plane end control point 516C (i.e. the difference between the elevation of the design plane end control point 516C and the elevation of the slot end point 513); the elevation of the point on the design plane line 514 that the user is interacting with; and/or the depth of the current point on the design plane line 514 that the user is interacting with (i.e. the difference between the elevation of the point on the design plane that the user is interacting with and the elevation of a corresponding point on the current surface line 511).

In certain embodiments the computer processing system 300 is configured to either prevent certain adjustments from being made or to issue a warning to a user if the user attempts to make certain adjustments. For example, if an adjustment causes or would cause the slope/grade of the design plane line 514 to exceed a predefined threshold (e.g. the slope at which the machine 10 that will be operated to form the slot can no longer operate efficiently), the computer processing system 300 may prevent the adjustment from being made, or allow the user to make the adjustment but issue a warning (e.g. a visual and/or audible alert) advising the user that the slope has exceeded the threshold.

The various elements of the profile depiction 510 may be displayed in different colours and/or formats to allow for quick and simple visual identification of those elements. For example, the current surface line 511 may be displayed as a yellow line (or any other colour) and the final design plane line 514 may be displayed a blue line (or any other colour that is different to the colour of the current surface line 511). The carry indication 518 may be provided as a shaded area through which the current surface line 511 and design plane line 514 are visible.

### Top Down View Area 504

In the top down view area 504 the computer processing system 300 displays a top-down depiction of an area 530 of the work site 100 in which slots are being designed.

In the top view area 504 the computer processing system 300 displays a depiction of a footprint 532 of the slot being designed. As can be seen, this top down view does not provide any indication of how close the current surface is to the final target design (e.g. the dragline pad).

In the top down view area 504 the computer processing system 300 also displays navigation tools 534 which a user can interact with to change the area 530 of the work site 100 being viewed. In the present embodiment the navigation tools 534 include a panning tool 536 (which a user can interact with to pan the work site area being displayed) and a zoom tool 538 (which a user can interact with to zoom in or out of the work site area).

In the top view area 504 the computer processing system 300 also displays a scale 540 (in this case showing the scale of the area currently being displayed in both meters and feet). If the zoom level is changed (by interaction with the zoom tool 538) the scale 540 is adjusted to reflect the new zoom level.

As can be seen the footprint 532 of the slot being designed is a rectangle. In FIG. 5 only a single slot footprint 532 is shown. If multiple slots have been designed in the work-block all slots will be shown and the user can select different slots by, for example, clicking on the footprint 532 of the desired slot. Computer processing system 300 provides the footprint 532 with (in this example) two footprint control points 542A and 542B. Footprint control points 542A and 542B indicate the start and end points of the slot and as such correspond to the slot start and end points 512 and 513 in the profile depiction 510. In certain embodiments system 300 permits a user to interact with a footprint control point 542 (in a similar fashion to design plane control points 516 as described above) in order to adjust the length of the slot (e.g. by dragging one footprint control point 542 closer to or further away from the other footprint control point 542). In other embodiments the system 300 does not permit any adjustment to the footprint (i.e. the position and shape of the footprint 532 is automatically generated and fixed by the system 300).

In certain embodiments the width of the slot is controlled by the computer processing system 300 and cannot be adjusted by a user. In this case the width is set/maintained at a defined slot width according to the capabilities of the machine 10 (and in particular the width of the machine's work implement 16) that will be assigned to form the slot.

If a user interacts with the footprint to adjust the length of the slot, corresponding adjustments are made in the slot details area 506 (in particular to the slot length field as described further below). Corresponding adjustments may also be made to the profile depiction of the slot 510 in the profile view area 502.

### Slot Details Area 506

In the slot details area 504 the computer processing system 300 displays numeric details of the current design of the slot.

A slot name field 550 is provided which displays a unique identifier for the slot.

A start elevation field 552 is provided which displays the elevation of the start of the slot (e.g. the elevation of the design plane start control point 516A) as currently shown by the profile depiction 510. The start elevation may, for example, be a number of meters above or below sea level or any other reference altitude.

A slope (or grade) field 554 is provided which displays the slope of the design plane line 514 as currently shown in the profile depiction 510. The slope may, for example, be displayed as a percentage (i.e. 100*(depth/length)%). Alternatively, the slope may be displayed as an angle calculated (for example) between the current surface line 511 and the design plane line 514.

A depth field 556 is provided which displays the depth of the slot as currently shown by the profile depiction 510. The depth of the slot is the vertical distance between the elevation of the current surface line 511 (or, if the current surface line 511 is not a constant elevation, the elevation of the slot end point 513) and the elevation of the design plane end control point 516C (e.g. in meters).

An end elevation field 558 is provided which displays the elevation of the design plane end control point 516C (e.g. in meters above/below a known reference altitude).

A slot length field 560 is provided which displays the length (e.g. in meters) of the slot as currently shown by the footprint 532 (i.e. between the two footprint control points 542) and the profile depiction 510 (i.e. between the slot start point 512 and slot end point 513).

If a user makes an adjustment to the slot being designed—e.g. by manipulating the profile view 510 and/or the footprint 532—any affected slot details are also changed accordingly. For example: if a user makes an adjustment that causes the elevation of the design plane start control point 516A to change, the start elevation field 552 is updated to display the adjusted elevation; if a user makes an adjustment that causes the elevation of the design plane end control point 516C to change, the end elevation field 558 is updated to display the adjusted elevation; if a user makes an adjustment that causes the slope of the design plane line 514 to change, the slope field 554 is updated to display the adjusted slope; if a user makes an adjustment that causes the depth of the slot to change, the depth field 556 is updated to display the adjusted depth; if a user makes an adjustment that causes the length of the slot to change, the length field 560 is updated to display the adjusted length.

In certain embodiments, the computer processing system 300 is configured to allow adjustment of certain slot details by direct entry into the relevant field. By way of example, in the illustrated embodiment, the computer processing system 300 permits direct entry into the start elevation field 552, slope field 554, and depth field 556. Direct entry into the end elevation 558 and slot length field 560 is, however, not enabled in the illustrated embodiment (as shown by the greyed out field boxes).

Direct entry into a details field (where enabled) may be made by selecting the field (e.g. clicking on the field or tabbing to the field by operation of a keyboard) and entering the required detail (e.g. by a keyboard number pad or the like). Where details are directly entered into a field the computer processing system 300 automatically calculates any other field data that may change as a result, and displays all changes in all relevant views.

For example, if a user directly enters a start elevation into the start elevation field 552 the computer processing system 300: adjusts the position of the design plane start control point 516A to be the entered elevation (the lateral position of the start control point 516A being maintained at its current location); recalculates the coordinates of the design plane line 514 to be a straight line joining the design plane start control point 516A (in its adjusted position) and the design plane end control point 516C (in its original position); updates the profile depiction 510 to reflect the new design plane line 514 (and carry indication 518); and updates the slope field 554 to reflect the new slope of the design plane line 514.

As a further example, if a user directly enters a slope into the slope field 554 the computer processing system 300: calculates a new elevation for the design plane end control point 516C (the new elevation based on the new slope and the original position of the design plane start control point 516A); calculates a new depth (by subtracting the newly calculated end elevation from the current surface elevation); displays the new end elevation in the end elevation field 558; and updates the design plane line 514 (and carry indication 518) to display a design plane line 514 with the new end elevation and slope.

As a further example, if a user directly enters a depth into the depth field 556 the computer processing system 300: calculates a new elevation for the design plane end control point 516C (by subtracting the newly entered depth from the current surface elevation); calculates a new slope (based on the original design plane start control point 516A and the new position of the design plane end control point 516C); displays the new slope in the slope field 554; displays the new end elevation in the end elevation field 558; updates the design plane line 514 (and carry indication 518) to display the new end elevation and slope.

Although, in some embodiments, entry of certain slot parameters by keyboard into a relevant field is enabled, the complex environment in which human operators work is such that adjusting details of the slot being designed using a pointing device 320 to directly manipulate the profile depiction 510 is more efficient/user friendly. In some embodiments keyboard entry is disabled for all slot parameter fields and manipulation is only possible via interaction with the profile depiction 510 by a pointing device 320.

### Controls Area 508

In the controls area 508 the computer processing system 300 displays various commands that a user can invoke with respect to the slot being designed. In this instance three controls are provided: a save control 570, a cancel control 572, and a draft control 574. A user can activate a control by, for example, operating the pointing device 320 to move the cursor 522 onto the command and clicking/activating a button of the pointing device 320, or (in the case of a touch screen display) by contacting the control directly.

On activation of the save control 570, the current details/parameters of the slot being designed are saved.

In certain embodiments, once a slot design has been saved the computer processing system automatically assigns the slot design to a particular machine 10 as a terrain modification plan. This involves the computer processing system 300 generating a terrain modification plan based on the slot design and communicating the terrain modification plan to the designated machine 10. The machine control system 30 receives the design, processes it, and operates the machine 10 to form the slot as per the design parameters.

In other embodiments a saved slot design is not automatically used to generate and communicate a terrain modification plan to a machine 10. In this case a user further interacts with the computer processing system 300 (via an appropriate user interface) to generate the plan, select a machine 10 to carry out the plan, and communicate the plan to that machine 10.

On activation of the cancel control 572, the current details/parameters of the slot being designed are discarded. In certain embodiments, activation of the cancel control 542 closes the slot design user interface. In other embodiments, activation of the cancel control returns the current slot being designed to its last saved state/configuration.

As will be appreciated, the slot design graphical user interface 500 allows an operator to design a slot solely by interacting with a pointing device 320 (e.g. a mouse, joystick, touchpad, touch screen, or the like). No keyboard interaction is necessary. In certain operating environments this provides for a more efficient and user-friendly interface for designing slots.

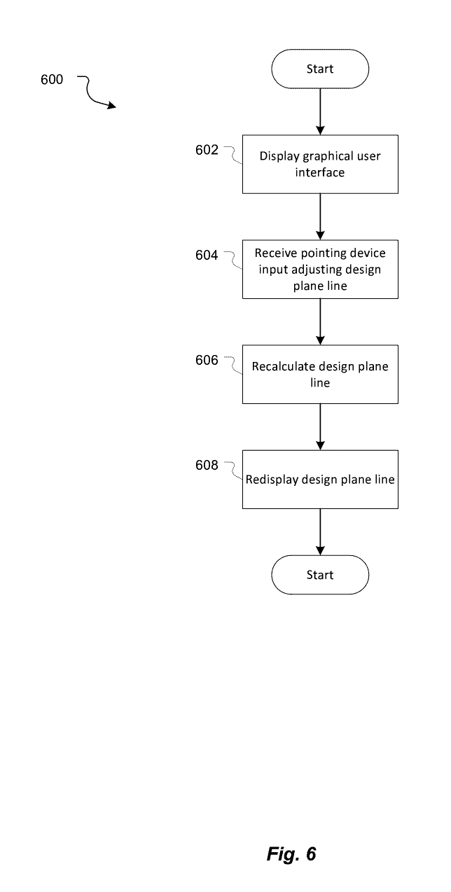

FIG. 6 is a flowchart 600 depicting high level/functional processing blocks involved in designing a terrain modification plan using the graphical user interface of FIG. 5.

At block 602, the computer processing system 300 displays a terrain modification graphical user interface. The terrain modification graphical user interface includes at least a profile depiction of terrain being planned (e.g. a profile depiction 510 of a slot being designed).

At block 604, the computer processing system 300 receives input from a pointing device 320 that adjusts the elevation of a point on design plane line 514 of the graphical user interface. In certain embodiments the pointing device input may be input corresponding to dragging a point on the design plane line 514 up or down to decrease/increase its elevation.

At block 606, the computer processing system 300 recalculates the design plane line 514 to account for the adjustment made at 604. Recalculation of the design plane line 514 may involve recalculation of: an elevation of the start of the design plane line (e.g. a design plane start control point 516A); an elevation of the end of the design plane line (e.g. a design plane end control point 516C); a slope of the design plane line; a depth below the current surface of the end of the design plane line.

At block 608, the computer processing system 300 redisplays the profile depiction 510 (or, at least, the design plane line 514) in accordance with the calculations performed at 606. Where slot details are displayed numerically (for example in a details area such as 506 described above), the numeric details are also redisplayed in accordance with the calculations.

The graphical user interface and features described above have been described with reference to the design/planning of slot dozing operations. The graphical user interface may, however, be used (or be adapted to be used) for other terrain modification planning. By way of one example, the graphical user interface/features may be used to assist in designing sloped roads.

The following clauses describe certain embodiments of the present disclosure by way of non-limiting example:
Clause 1. A computer processing system comprising:
   a computer processing unit;
   computer readable memory in communication with the computer processing unit, the computer readable memory storing instructions executable by the computer processing unit to cause the computer processing system to:
      display, on a display, a profile depiction of a work site terrain feature being designed, the profile depiction comprising a design plane line depicting a desired surface profile of the terrain feature;
      receive input from a pointing device, the input adjusting the elevation of a point on the design plane line;
      based on receiving input adjusting the elevation of the point on the design plane line, recalculate coordinates of the design plane line in accordance with the input received from the pointing device; and
      redisplay the design plane line in accordance with the recalculated coordinates.
Clause 2. The computer processing system of clause 1, wherein the profile depiction further comprises a current surface line depicting a current terrain surface at the location of the terrain feature being designed.
Clause 3. The computer processing system of clause 1 or clause 2, wherein the profile depiction further comprises a depth axis against which the profile depiction is displayed.
Clause 4. The computer processing system of any one of clauses 1 to 3, wherein the work site is a mining work site, and wherein the terrain feature being designed is a slot.
Clause 5. The computer processing system of any one of clauses 1 to 4, wherein the instructions further cause the computer processing unit to generate a terrain modification plan using the recalculated design plane coordinates, the terrain modification plan assignable to a work site machine to cause the work site machine to autonomously perform operations to generate the terrain feature.
Clause 6. The computer processing system of any one of clauses 1 to 5, wherein the instructions further cause the computer processing unit to display a top-down view of the work site terrain feature being designed.
Clause 7. The computer processing system of any one of clauses 1 to 6, wherein the instructions further cause the computer processing unit to display numeric details of selected parameters of the design plane line.
Clause 8. The computer processing system of clause 7, wherein the selected parameters of the design plane line are selected from a group comprising: a start elevation; a slope; a depth; and an end elevation.
Clause 9. The computer processing system of any one of clauses 1 to 8, wherein the pointing device is a cursor control device.
Clause 10. The computer processing system of any one of clauses 1 to 9, wherein the pointing device is selected from a group comprising: a mouse; a trackball; a track-pad; a joystick; and a pointing stick.
Clause 11. A non-transitory computer-readable medium comprising instructions which, when implemented by a computer processing system, cause the computer processing system to:
   display, on a display, a profile depiction of a work site terrain feature being designed, the profile depiction comprising a design plane line depicting a desired surface profile of the terrain feature;
   receive input from a pointing device, the input adjusting the elevation of a point on the design plane line;
   based on receiving input adjusting the elevation of the point on the design plane line, recalculate coordinates of the design plane line in accordance with the input received from the pointing device; and
   redisplay the design plane line in accordance with the recalculated coordinates.
Clause 12. The non-transitory computer-readable medium of clause 11, wherein the profile depiction further comprises a current surface line depicting a current terrain surface at the location of the terrain feature being designed.
Clause 13. The non-transitory computer-readable medium of clause 11 or clause 12, wherein the profile depiction further comprises a depth axis against which the profile depiction is displayed.
Clause 14. The non-transitory computer-readable medium of any one of clauses 11 to 13, wherein the work site is a mining work site, and wherein the terrain feature being designed is a slot.
Clause 15. The non-transitory computer-readable medium of any one of clauses 11 to 14, wherein the instructions further cause the computer processing unit to generate a terrain modification plan using the recalculated design plane coordinates, the terrain modification plan assignable to a work site machine to cause the work site machine to autonomously perform operations to generate the terrain feature.
Clause 16. The non-transitory computer-readable medium of any one of clauses 11to 15, wherein the instructions further cause the computer processing unit to display a top-down view of the work site terrain feature being designed.
Clause 17. The non-transitory computer-readable medium of any one of clauses 11 to 16, wherein the instructions further cause the computer processing unit to display numeric details of selected parameters of the design plane line.
Clause 18. The non-transitory computer-readable medium of clause 17, wherein the selected parameters of the design plane line are selected from a group comprising: a start elevation; a slope; a depth; and an end elevation.
Clause 19. The non-transitory computer-readable medium of any one of clauses 11 to 18, wherein the pointing device is a cursor control device.
Clause 20. The non-transitory computer-readable medium of any one of clauses 11 to 19, wherein the pointing device is selected from a group comprising: a mouse; a trackball; a track-pad; a joystick; and a pointing stick.

As used herein, the term “comprises” (and grammatical variants thereof) is used inclusively and does not exclude the existence of additional features, elements or steps.

It will be understood that embodiments extend to all alternative combinations of two or more of the individual features mentioned or evident from the text or drawings. All of these different combinations constitute various alternative aspects.

1. A computer processing system comprising:
a computer processing unit;
computer readable memory in communication with the computer processing unit, the computer readable memory storing instructions executable by the computer processing unit to cause the computer processing system to:
display, on a display, a profile depiction of a work site terrain feature being designed, the profile depiction comprising a design plane line depicting a desired surface profile of the terrain feature;
receive input from a pointing device, the input adjusting the elevation of a point on the design plane line;
based on receiving input adjusting the elevation of the point on the design plane line, recalculate coordinates of the design plane line in accordance with the input received from the pointing device; and
redisplay the design plane line in accordance with the recalculated coordinates.

2. The computer processing system of claim 1, wherein the profile depiction further comprises a current surface line depicting a current terrain surface at the location of the terrain feature being designed.

3. The computer processing system of claim 1, wherein the profile depiction further comprises a depth axis against which the profile depiction is displayed.

4. The computer processing system of claim 1, wherein the work site is a mining work site, and wherein the terrain feature being designed is a slot.

5. The computer processing system of claim 1, wherein the instructions further cause the computer processing unit to generate a terrain modification plan using the recalculated design plane coordinates, the terrain modification plan assignable to a work site machine to cause the work site machine to autonomously perform operations to generate the terrain feature.

6. The computer processing system of claim 1, wherein the instructions further cause the computer processing unit to display a top-down view of the work site terrain feature being designed.

7. The computer processing system of claim 1, wherein the instructions further cause the computer processing unit to display numeric details of selected parameters of the design plane line.

8. The computer processing system of claim 7, wherein the selected parameters of the design plane line are selected from a group comprising: a start elevation; a slope; a depth; and an end elevation.

9. The computer processing system of claim 1, wherein the pointing device is a cursor control device.

10. The computer processing system of claim 1, wherein the pointing device is selected from a group comprising: a mouse; a trackball; a track-pad; a joystick; and a pointing stick.

11. A non-transitory computer-readable medium comprising instructions which, when implemented by a computer processing system, cause the computer processing system to:
display, on a display, a profile depiction of a work site terrain feature being designed, the profile depiction comprising a design plane line depicting a desired surface profile of the terrain feature;
receive input from a pointing device, the input adjusting the elevation of a point on the design plane line;
based on receiving input adjusting the elevation of the point on the design plane line, recalculate coordinates of the design plane line in accordance with the input received from the pointing device; and
redisplay the design plane line in accordance with the recalculated coordinates.

12. The non-transitory computer-readable medium of claim 11, wherein the profile depiction further comprises a current surface line depicting a current terrain surface at the location of the terrain feature being designed.

13. The non-transitory computer-readable medium of claim 11, wherein the profile depiction further comprises a depth axis against which the profile depiction is displayed.

14. The non-transitory computer-readable medium of claim 11, wherein the work site is a mining work site, and wherein the terrain feature being designed is a slot.

15. The non-transitory computer-readable medium of claim 11, wherein the instructions further cause the computer processing unit to generate a terrain modification plan using the recalculated design plane coordinates, the terrain modification plan assignable to a work site machine to cause the work site machine to autonomously perform operations to generate the terrain feature.

16. The non-transitory computer-readable medium of claim 11, wherein the instructions further cause the computer processing unit to display a top-down view of the work site terrain feature being designed.

17. The non-transitory computer-readable medium of claim 11, wherein the instructions further cause the computer processing unit to display numeric details of selected parameters of the design plane line.

18. The non-transitory computer-readable medium of claim 17, wherein the selected parameters of the design plane line are selected from a group comprising: a start elevation; a slope; a depth; and an end elevation.

19. The non-transitory computer-readable medium of claim 11, wherein the pointing device is a cursor control device.

20. The non-transitory computer-readable medium of claim 11, wherein the pointing device is selected from a group comprising: a mouse; a trackball; a track-pad; a joystick; and a pointing stick
